(19) United States
(12) Patent Application Publication
(10) Pub. No.: US 2013/0034839 A1
(43) Pub. Date: Feb. 7, 2013

(54) Computer Method And System Determining What Learning Elements Are Most Effective

(71) Applicant: Neil T. Heffernan, Shrewsbury, MA (US)

(72) Inventor: Neil T. Heffernan, Shrewsbury, MA (US)

(21) Appl. No.: 13/642,091

(22) PCT Filed: Mar. 8, 2012
(86) PCT No.: PCT/US12/28270

§ 371 Date: Oct. 18, 2012

Related U.S. Application Data
(60) Provisional application No. 61/451,815, filed on Mar. 11, 2011.

(51) Int. Cl. G09B 7/00

(52) U.S. Cl. 434/350

(57) ABSTRACT

Education is a very important topic and educators are constantly attempting to improve manners in which education is provided to student. However, Educators often disagree as to the best techniques for educating students. Further, as technology is increasing the manner in which education is performed must keep up and take advantage of the current and anticipated developments in technology. A problem that is faced by Educators is that there is no ability to easily test and implement techniques of educations. Embodiments of the present invention provide a method and system for conducting a controlled experiment to compare techniques of conveying information. The embodiments facilitate administration of the controlled experiment to a plurality of users via an online user interface. Using results of the controlled experiment, the embodiments determine a relative effectiveness of a technique for conveying information to at least one user of the plurality of users.

### RELATED APPLICATION(S)

This application claims the benefit of U.S. Provisional Application No. 61/451,815, filed on Mar. 11, 2011. The entire teachings of the above application is incorporated herein by reference.

### GOVERNMENT SUPPORT

This invention was made with government support under the U.S. Department of Education (Grant #R305K03140) and the National Science Foundation (Grant #0231773, Career Grant #REC-0448319 and a GK12 Grant #0742503). The government has certain rights in the invention

### BACKGROUND OF THE INVENTION

Tutoring systems are helpful in providing instruction to students. Computer automated and in particular intelligent tutoring systems (ITS) are however very complex and costly to construct. The term Intelligent Tutoring Systems covers a wide range of possible computer-based tutors, from cognitive model tracing tutors (Anderson, J. R., & Pelletier, R., “A development system for model-tracing tutors,” In Proceedings of the International Conference of the Learning Sciences, 1-8, 1991), to constraint-based tutors (Mitrovic, A., & Ohlsson, S., “Evaluation of a Constraint-Based Tutor for a Database Language”, Int. J on Artificial Intelligence in Education 10 (3-4), pp. 238-256, 1999), to pseudo-tutors. Pseudo-tutors are simplified cognitive models based on state graphs. The state graphs of pseudo-tutors are finite graphs with each node representing a state of the interface, and each arc representing an action made by a student. Student actions trigger transitions in the graph, and the current state of the problem is represented by the graph. Pseudo-tutors are behaviorally equivalent to rule-based tutors.

An ITS may typically be formed of several pseudo tutors. Each pseudo tutor is limited to solving a respective problem.

### SUMMARY OF THE INVENTION

Applicants leverage the large number of students that use ASSISTments described by assignee in:
U.S. Provisional Application No. 60/699,625 filed 15 Jul. 2005
Title: Global Computer Network Tutoring System
Inventor(s): Heffernan, Neil T.; Koedinger, Kenneth R.
U.S. application Ser. No. 11/989,791 filed 13 Jul. 2006
Title: Global Computer Network Tutoring System
Inventor(s): Heffernan, Neil T.; Koedinger, Kenneth R.
U.S. Provisional Application No. 60/908,579 filed 28 Mar. 2007
Title: Wiki-ASSISTments
Inventor(s): Duong, Due; Lloyd, Nicholas; Pardos, Zachary; Patvarczki, Jozsef; Razzaq, Leena; Heffernan, Neil
U.S. patent application Ser. No. 12/532,905 filed 25 Mar. 2008
Inventors: Heffernan, Neil T.
Title: Global Computer Network Self-Tutoring System
U.S. Provisional Application No. 60/937,953 filed 29 Jun. 2007
Title: Global Computer Network Self-Tutoring System
Inventor(s): Heffernan, Neil T.
U.S. Provisional Application No. 61/001,136 filed 31 Oct. 2007
Title: Method Or Apparatus For Increasing The Quality Of Student Learning
Inventor(s): Heffernan, Neil T.
U.S. patent application Ser. No. 12/738,060 filed 30 Oct. 2008
Title: Global Method and System for Increasing the Quality of Student Learning
Inventor(s): Heffernan, Neil T.,

herein incorporated by reference in their entirety.

An embodiment of the present invention is a method, system, or computer readable medium, with program codes embodied thereon, for conducting a controlled experiment to compare techniques of conveying information. For ease of reading, the term “system” is used in various portions of the description and may represent some or all forms of embodiments and implementations of the present invention, such as systems, methods, apparatuses, devices, computer readable media, network nodes, and networks.

The embodiment administers the controlled experiment (e.g., a randomized controlled experiment) to a plurality of users via an online user interface. Using results of the controlled experiment, the embodiment determines a relative effectiveness of a technique for conveying information to at least one user of the plurality of users.

The online user interface may be an online tutoring tool used to provide automated tutoring services. For example, the online tutoring tool may be a tool used to provide assignments, questions, problems, and exams to students for a variety of subjects (topics or areas of study). The controlled experiment may include at least one condition assigned to the plurality of users.

The embodiment may also include assigning the at least one condition randomly. In addition, the at least one condition may include the technique of conveying the information to the at least one user. Further, the information may also include a skill required for solving a problem. For instance, the skill may include a knowledge component of a subject area including at least one of the following: mathematics, history, the sciences, English, foreign languages, religion, business, and politics.

Additionally, administering the controlled experiment may include determining a pre-experiment knowledge base of the information associated with a subset of the plurality of users and a post-experiment knowledge base of the information associated with the subset of the plurality of users. Determining the pre-experiment knowledge base of the information and post-experiment knowledge base may also include administering a pre-experiment examination and a post-experiment examination. Also, determining the relative effectiveness of the technique of conveying information includes analyzing results of the pre-experiment examination and the post-experiment examination.

The embodiment may further include enabling an administrator of the controlled experiment to design and build the technique for conveying the information to the plurality of users. The embodiment may also include enabling an administrator of the controlled experiment to create questions and problems that are to be presented to the plurality of users as part of the controlled experiment. Further, the embodiment enables the administrator to control a sequence or pattern in which the questions and problems are presented to the plurality of users, the sequence or pattern being associated with the technique for conveying information.

The embodiment may also map skills and knowledge components associated with the information to the questions and problems. Additionally, the embodiment includes tracking accumulated knowledge of each of the plurality of users based on responses to the questions and problems associated with skills and knowledge components via the mappings. Tracking the accumulated knowledge may include performing longitudinal data analysis of the responses.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic view of a computer network system embodying the present invention.

FIG. 2 is a block diagram of a computer node in the network of FIG. 1.

FIG. 3 is a block diagram of a network architecture in which embodiments of the present invention operate.

FIG. 4 illustrates an example ASSISTment system in accordance to an embodiment of the present invention.

FIG. 5 illustrates a problem sequence that is used to run an experiment that compares tutoring students using scaffolding questions to tutoring students with hints.

FIG. 6 is a flow diagram of a method and system for determining a relative effectiveness of a technique for conveying information.

### DETAILED DESCRIPTION OF THE INVENTION

A description of example embodiments of the invention follows. Education is a very important topic and Educators are constantly attempting to improve manners in which education is provided to students. However, Educators often disagree as to the best techniques for educating students. Further, as technology is increasing the manner in which education is performed must keep up and take advantage of the current and anticipated developments in technology. A problem that is faced by Educators is that there is no ability to easily test and implement techniques of educations. Similarly, there is no known method of easily learning what web pages or learning elements are most effective at increasing student learning. For example, Google® has no way of determining (or learning) what web pages are most effective at increasing student learning.

Embodiments of the present invention provide a method and system for conducting a controlled experiment (e.g., randomized controlled experiment) to compare techniques of conveying information. The embodiments facilitate administration of the controlled experiment to a plurality of users via an online user interface. Using results of the controlled experiment, the embodiments determine a relative effectiveness of a technique for conveying information to at least one user of the plurality of users.

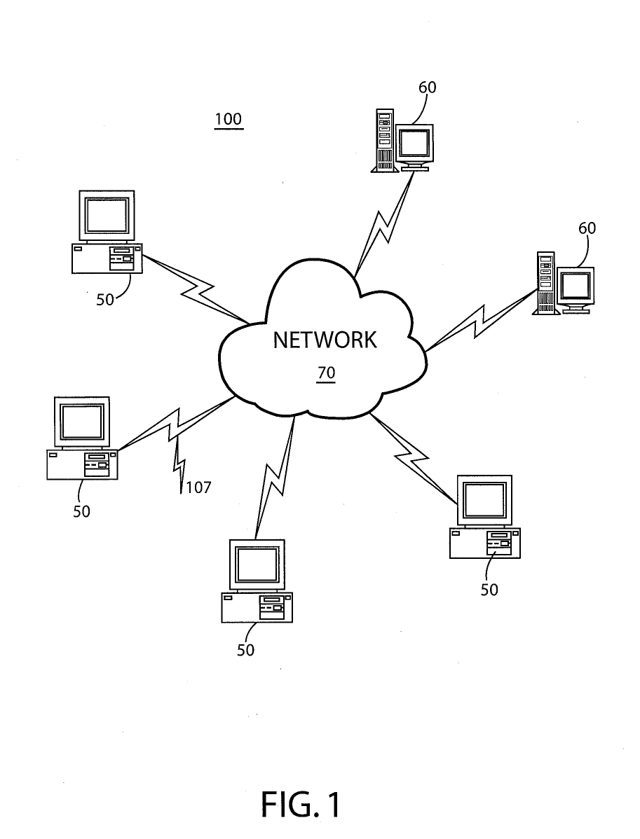

FIG. 1 illustrates a computer network or similar digital processing environment in which the present invention may be implemented. A non-limiting example system 100 embodying the present invention comprises at least one client computer/device 50 and a server computer 60.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

In particular, clients 50 and servers 60 are configured to operate and support the tutoring sessions and functions as described in:
U.S. Patent Publication No. 2008/0254437 (published Oct. 16, 2008);
U.S. Patent Publication No. 2010/0285441 (published Nov. 11, 2010);
U.S. Patent Publication No. 2010/0279265 (published Nov. 4, 2010)
by assignee and herein incorporated by reference.

Further, methods 100 embodying the present invention assign students at random to conditions. Then the method/system 100 monitors and tracks students under the assigned conditions operating the foregoing tutoring tools and sessions.

The monitoring and tracking collects data on each student and on the different ways that the tutoring sessions teach a subject or topic (e.g., 8^{th} grade level math). A comparator (human or automated) compares and otherwise analyzes the collected data and can determine which teaching methods appeared to help students learn (and thus were effective). And/or the comparator can determine relative effectiveness among the different teaching methods used by the tutoring tool and in the tutoring tools sessions.

In this way, by the present invention, the tutoring tools are made to administer randomized controlled experiments to large numbers of students. No programming skills are needed by the researchers. The present invention leverages the content authoring enabled by the tutoring tools. In particular, the preferred embodiment is a web-based tutoring system 100 that includes web based authoring tools that allows researchers to easily design, build and then compare different ways to teach a subject/topic.

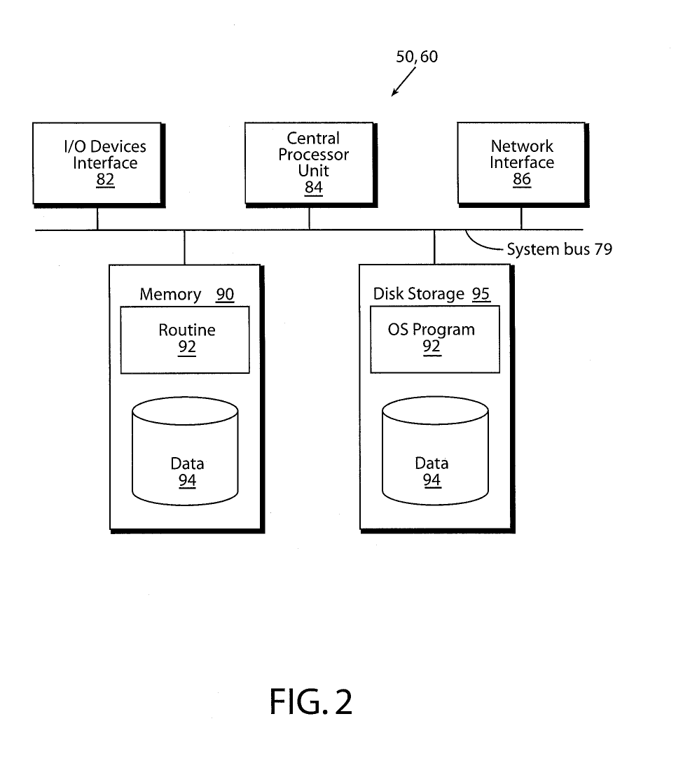

FIG. 2 is a diagram of the internal structure of a computer (e.g., client processor/device 50 or server computers 60) in the computer system of FIG. 1. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 1). Memory 90 provides volatile storage for computer software instructions 92 and data 94 used to implement an embodiment of the present invention (e.g., tutoring tools, randomized controlled experiments administration and supporting code detailed below). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

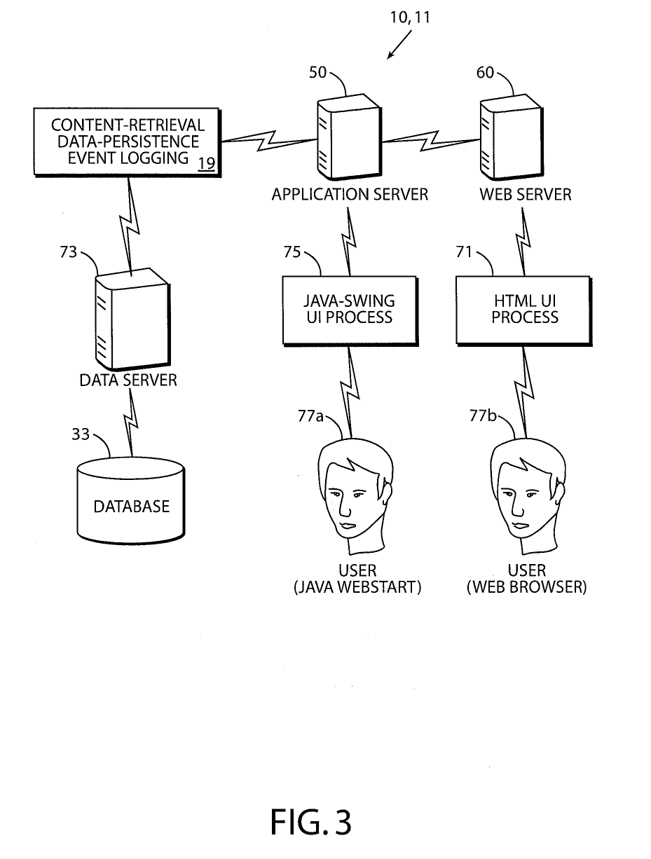

In a preferred embodiment, the network architecture is configured as shown in FIG. 3. The application server 50, web server 60 and data server 73 can run on one machine or separate machines. Additional web servers 60 can be added for load balancing. The data server 73 handles database requests and data persistence (i.e., file system or database 33 data storage and retrieval). The data server 73 is also responsive to user level and framework level events and logs the same in database 33. This effectively implements logging unit 19 discussed above. The database system 33 is any database with a JDBC driver.

Users on different platforms may use the same invention system 10 simultaneously. Illustrated is one user 77a obtaining access through a Java Webstart network software launch of the invention program experiment processor, and another user 77b obtaining access through a web browser supported by web server 60. The HTML user interface process 71 converts abstract user interface into HTML widgets as explained in FIG. 2 above. The Java Swing user interface process 75 converts the same abstract user interface into Java Swing widgets as previously detailed in FIG. 2. The user interactions represented as respective user interface widgets cause various content retrieval and storage events at application server 50, web server 60 and data server 73. Illustrated users 77 include teachers and students. Other configurations are suitable.

Education researchers often disagree about the best ways to improve student achievement. The difficulty of designing, conducting, and analyzing experiments means that there is often a dearth of empirical data to support or refute ideas. To design and conduct a simple randomized controlled experiment to compare two different ways of teaching requires a great deal of effort by a teacher or a researcher. The difficulty of conducting such experiments, and then later analyzing the results, is part of the reason that so few randomized controlled experiments are conducted in education. One of the goals of embodiments of the present invention (e.g., the ASSISTment System) is to reduce some of those difficulties. Embodiments of the present invention include web-based tools that allow researchers to easily design, build and then compare different ways to teach children. These tools can administer randomized controlled experiments to large numbers of students.

In addition, embodiments of the present invention support the full life cycle of content authoring via interactive tools. For example, embodiments, in an automated or computer-based way, enable teachers to create problems with tutoring, map each question to skill required to solve them, bundle problems together in sequences that students work on, view reports on students' work, maintain and refine the content over time.

One example embodiment of the disclosed computer-based/interactive tutoring tool consists of a single main problem (e.g., the original question). For any given problem, assistance may be made available to students in the form of either i) a hint sequence or ii) scaffolding questions. Hints are messages that provide insights and suggestions for solving a specific problem. Hints may be arranged in hint sequences, where each hint sequence may end with a bottom-out hint which gives the student the answer to the specific problem.

Scaffolding problems are designed to address specific skills needed to solve the original question. Students must answer each scaffolding question in order to proceed to the next scaffolding question. When students finish all of the scaffolding questions, they may be presented with the original question again to finish the problem. In other words, embodiments of the present invention use scaffolding questions to break down a question into smaller parts, identify the skills needed to solve each part, and creates questions associated with the smaller parts for the student to answer. In this way, embodiments may be able to identify the specific part/step of a question (e.g., because questions may require multiple steps to solve them) the student is having difficulty with and then dynamically adjust a tutoring session to educate the student on that specific portion. Alternatively, the tutoring system may identify the student's weaknesses and then address those weaknesses in a subsequent tutoring session.

In addition, each scaffolding question may also include a hint sequence to help the students answer the question if they need extra help. Further, messages called buggy messages are provided to students if certain anticipated incorrect answers are selected or entered. For problems without scaffolding, the system has a student remain in a problem until the problem is answered correctly and can ask for hints, which are presented by the system one at a time. If scaffolding is available, the system programmatically advances the student to the first scaffolding problems in the event of an incorrect answer on the original question.

Hints, scaffolds, and buggy messages together help create ASSISTments (tutoring session logical elements) that are structurally simple but can address complex student behavior. The structure and the supporting interface used to build ASSISTments are simple enough so that educator-users with little or no computer science and cognitive psychology background can use it easily.

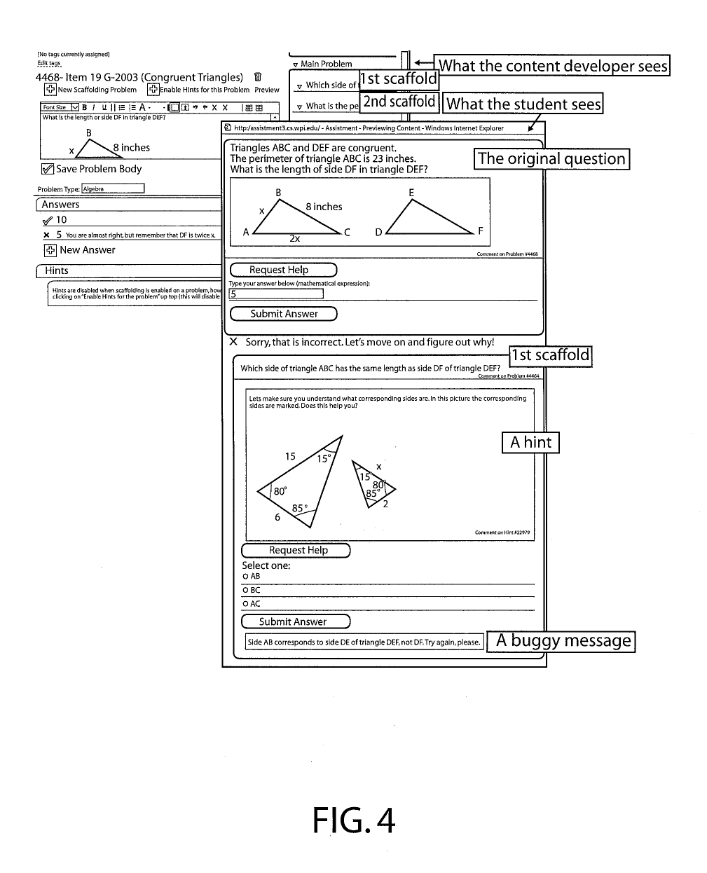

FIG. 4 illustrates an ASSISTment being built on the left and what the system presents to the student is shown on the right (window). Embodiments enable content authors (educator-users) to easily enter question text, hints and buggy messages by clicking on the appropriate field and typing; formatting tools are also provided.

Embodiments of the present tutoring and experimentation system assume that students may already know certain skills. Thus, rather than slowing them down by providing tutoring of individual problems (e.g., via hints and/or scaffolding), the current system enables a student to attempt to answer a problem without tutoring or teaching tools and techniques.

Further, an ASSISTment builder 40 enables the mapping of knowledge components, which are organized into sets known as transfer models. The knowledge components may then be used to map certain skills to specific problems to indicate that a problem requires knowledge of that skill. Mapping between skills and problems allows embodiments of the present invention to track student knowledge over time using longitudinal analysis techniques. For instance, if a student consistently answers problems requiring a specific skill correctly, embodiments of the present invention are configured to determine that the student has acquired (i.e., learned) the skill. Conversely, if the student answers such a problem incorrectly, embodiments of the present invention may implement a technique to convey the skill associated with the problem to the student. Embodiments may also dynamically change the technique if the student continues to answer problems associated with the skill incorrectly.

Additionally, embodiments of the present invention may arrange problems into problem sequences. Each sequence may be composed of one or more sections of a subject area, with each section including additional problems or sub-sections. A section component, an abstraction for a particular ordering of problems, has been extended to implement our current section types and allows for new types to be added in the future. Section types may include “Linear” (problems or subsections are presented in linear order), “Random” (problems or sub-sections are presented in a pseudo-random order), and “Choose Condition” (a single problem or sub-section is selected pseudo-randomly from a list, the others are ignored). The “Choose Condition” section is used to randomly assign students to a condition within an experiment. In addition, a problem sequence may exist or be created for any skill identified by embodiments of the present invention. Teachers may easily choose a Problem Sequence from a list of approved sequences and assign them to their classes (students). Teachers may also create their own sequences from ASSISTments available in the system or from ASSISTments that they authored.

Embodiments of the present invention, utilize the ASSITment system to find the best way to tutor each individual and/or groups of students (e.g., convey (teach) information/skills to a student) and easily build problem sequences in order to run randomized controlled experiments.

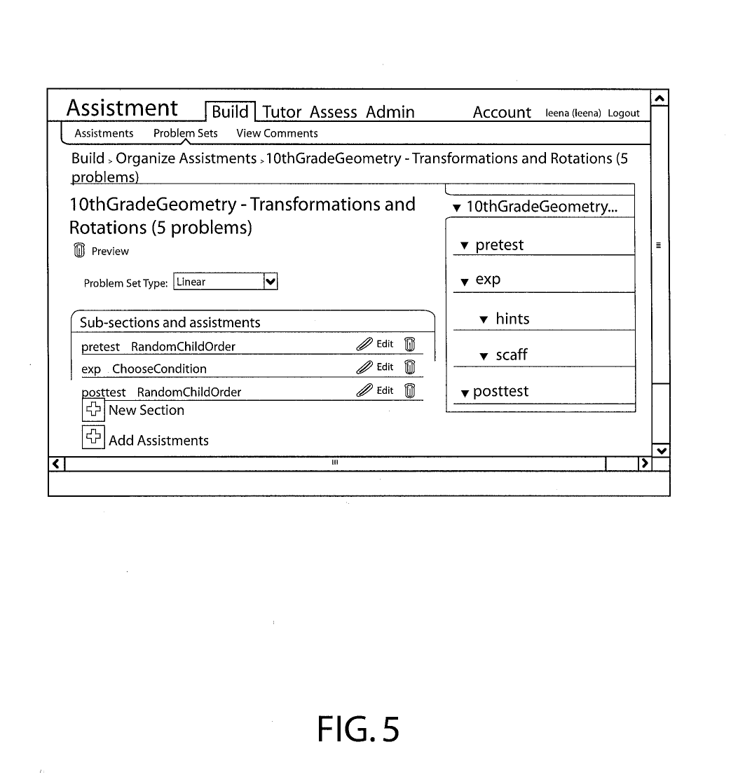

FIG. 5 illustrates a problem sequence (configured through Builder 40) that is used to run an experiment that compares tutoring students using scaffolding questions to tutoring students with hints.

Three main sections are presented in linear order: a pre-test, experiment, and post-test sections. The pre-test and post-test sections are random sections and present the questions in a random order. The invention system (via Builder 40) allows authors (teacher-users) to label an ASSISTment as a “test” question, which means that students will get no feedback on that question. This allows embodiments of the present invention to compare gains (i.e., knowledge obtained) from pre-test to post-test. The experiment section is a Choose Condition section. Within the experiment section there are two conditions and students are randomly presented with one of them.

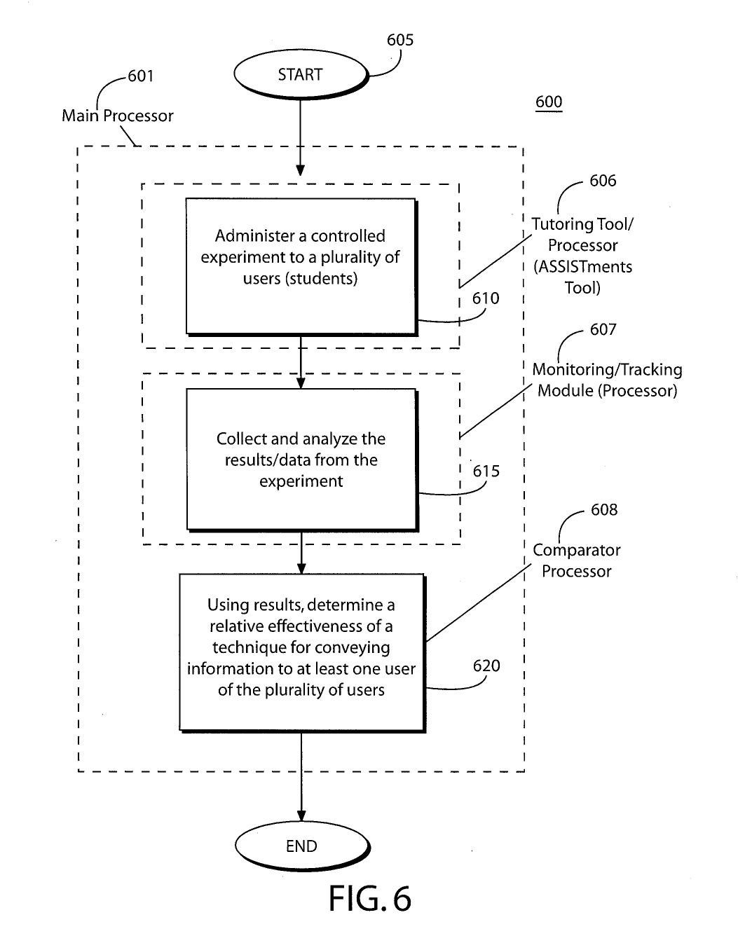

FIG. 6 is a flow diagram of a method and system 600 for determining a relative effectiveness of a technique for conveying information. Each step may be performed by main processor 601. At step 605, the method and system 600 begins and has access to stored problem sequences and configured experiments from Builder 40 of FIGS. 4 and 5. At step 610, a tutoring tool/processor 606 (ASSISTments tutoring tool) administers a controlled experiment to a plurality of users. The controlled experiment includes a control (e.g., the subject being taught) and a condition (e.g., the teaching technique) being analyzed. For instance, the condition may be one condition or multiple conditions. As stated above, example conditions (techniques for conveying information) may include the use of hints or scaffolding of problems.

Once the experiment is administered 610, the method at step 615 and system 600 collects and analyzes results/data from the experiment. This may be performed by monitoring/tracking module (processor) 607 applying skill tracking and other knowledge acquisition determination techniques.

At step 620, the system and method 600, using the results of the experiment, determines the relative effectiveness of a technique for conveying information to at least one user of the plurality of users. This may be performed by comparator processor 608 employing common/known comparison measuring (gains) techniques, test group analysis techniques and other pertinent techniques. Processor 608 provides resulting indications or measurements of relative effectiveness of the tested technique for conveying information as output to the educator-users of system 600.

It should be noted that advantages of the present invention enable the method and system 600 to determine the relative effectiveness of conveying information to a specific user or the plurality of users as a whole. For instance, it is well known that every person is unique and has different learning styles and capabilities of comprehending information. For example, some may be visual learners while some may learn via verbal communications. The method and system 600 is able to determine the relative effectiveness of a teaching technique for the individual learner and the plurality of users. In other words, the current system may enable improved teaching of students at the individual level using the determined relative effectiveness of a teaching technique with respect to the individual student. Alternatively, the system may use a different teaching technique that is shown to be beneficial for a majority of students in a classroom setting and a webinar with multiple student attendees.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

1. In a global computer network, a method, executed by a computer node within the global network for conducting a controlled experiment to compare techniques of conveying information, the method comprising:
administering the controlled experiment to a plurality of users via an online user interface; and
using results of the controlled experiment, determining a relative effectiveness of a technique for conveying information to at least one user of the plurality of users.

2. The method of claim 1, wherein the online user interface is an online tutoring tool.

3. The method of claim 1, wherein the controlled experiment includes at least one condition assigned to the plurality of users.

4. The method of claim 3 further comprising assigning the at least one condition randomly.

5. The method of claim 3, wherein the at least one condition includes at least the technique of conveying the information to the at least one user.

6. The method of claim 1, wherein the information includes a skill required for solving a problem.

7. The method of claim 6, wherein the skill includes a knowledge component of a subject area including at least one of the following: mathematics, history, the sciences, English, foreign languages, religion, business, and politics.

8. The method of claim 1, wherein administering the controlled experiment includes determining a pre-experiment knowledge base of the information associated with a subset of the plurality of users and a post-experiment knowledge base of the information associated with the subset of the plurality of users.

9. The method of claim 8 wherein determining the pre-experiment knowledge base of the information and post-experiment knowledge base includes administering a pre-experiment examination and a post-experiment examination.

10. The method of claim 9, wherein determining the relative effectiveness of the technique of conveying information includes analyzing results of the pre-experiment examination and the post-experiment examination.

11. The method of claim 1 further comprising enabling an administrator of the controlled experiment to design and build the technique for conveying the information to the plurality of users.

12. The method of claim 1 further comprising enabling an administrator of the controlled experiment to create questions and problems that are to be presented to the plurality of users as part of the controlled experiment.

13. The method of claim 12 further comprising enabling the administrator to control a sequence or pattern in which the questions and problems are presented to the plurality of users, the sequence or pattern being associated with the technique for conveying information.

14. The method of claim 12 further comprising mapping skills and knowledge components associated with the information to the questions and problems.

15. The method of claim 14 further comprising tracking accumulated knowledge of each of the plurality of users based on responses to the questions and problems associated with skills and knowledge components via the mappings.

16. The method of claim 15, wherein tracking the accumulated knowledge includes performing longitudinal data analysis of the responses.

17. In a global computer network, a computer system for conducting a controlled experiment to compare techniques of conveying information, the system comprising:
a processor configured to administer a controlled experiment to a plurality of users via an online user interface; and
using results of the controlled experiment, the processor further configured to determine a relative effectiveness of a technique for conveying information to at least one user of the plurality of users.

18. The system of claim 17, wherein the online user interface is an online tutoring tool.

19. The system of claim 17, wherein the controlled experiment includes at least one condition assigned to the plurality of users.

20. The system of claim 19, wherein the processor is further configured to assign the at least one condition randomly.

21. The system of claim 17, wherein the at least one condition includes at least the technique of conveying the information to the at least one user.

22. The system of claim 17, wherein the information includes a skill required for solving a problem.

23. The system of claim 22, wherein the skill includes a knowledge component of a subject area including at least one of the following: mathematics, history, the sciences, English, foreign languages, religion, business, and politics.

24. The system of claim 17, wherein the processor is further configured to determine a pre-experiment knowledge base of the information associated with a subset of the plurality of users and a post-experiment knowledge base of the information associated with the subset of the plurality of users.

25. The system of claim 24, wherein the processor is further configured to administer a pre-experiment examination and a post-experiment examination.

26. The system of claim 25, wherein the processor is further configured to analyze results of the pre-experiment examination and the post-experiment examination.

27. The system of claim 17, wherein the processor is further configured to enable an administrator of the controlled experiment to design and build the technique for conveying the information to the plurality of users.

28. The system of claim 17, wherein the processor is further configured to enable an administrator of the controlled experiment to create questions and problems that are to be presented to the plurality of users as part of the controlled experiment.

29. The system of claim 28, wherein the processor is further configured to enable the administrator to control a sequence or pattern in which the questions and problems are presented to the plurality of users, the sequence or pattern being associated with the technique for conveying information.

30. The system of claim 28, wherein the processor is further configured to map skills and knowledge components associated with the information to the questions and problems.

31. The system of claim 30, wherein the processor further configured to track accumulated knowledge of each of the plurality of users based on responses to the questions and problems associated with skills and knowledge components via the mappings.

32. The system of claim 31, wherein the processor is further configured to perform longitudinal data analysis of the responses to determine the relative effectiveness of the technique for conveying the information.
